(19) United States
(12) Patent Application Publication
(10) Pub. No.: US 2025/0252162 A1
(43) Pub. Date: Aug. 7, 2025

(54) ZERO-TRUST SYSTEM AND METHOD

(71) Applicant: Venkata Radhakrishna Abburi, Aubrey, TX (US)

(72) Inventor: Venkata Radhakrishna Abburi, Aubrey, TX (US)

(21) Appl. No.: 18/431,525

(22) Filed: Feb. 2, 2024

(51) Int. Cl. G06F 21/10; G06F 21/60

(52) U.S. Cl. CPC G06F 21/1077; G06F 21/604; G06F 21/606

(57) ABSTRACT

A system and methods for a Zero Trust API which provides a robust and layered security approach, guaranteeing that access to sensitive data is controlled and secure at every step of the process. The Zero Trust API provides a system and methods for maintaining a high level of data privacy and security, even in complex and dynamic environments. The Zero Trust API provides a system and methods to ensure sensitive credentials or privileged accounts will be used via machine-to-machine approach and will restrict users from possessing the keys or credentials. The Zero Trust API system and methods ensure robust and layered security approach that can guarantee access to sensitive data that is controlled and secured at every instance of access.

### FIELD

The present disclosure relates to computer security, privacy and integrity and, more particularly, to a system and method for providing zero-trust security to enhance access-control and security in computer software.

### BACKGROUND

Synchronizing credentials with third parties is frequently a cause for concern within organizations, as it raises security red flags. Furthermore, the inadvertent exposure of personally identifiable information (PII) to employees is a significant privacy concern. Existing tools that assist in development, testing, and CI/CD processes, often fall short in terms of safeguarding sensitive data, leading to potential exposure within the organization and inadvertent data synchronization with third-party cloud services, which significantly expands the attack surface and leaves organizations unaware of potential credential leaks. Existing tools evidence security and privacy concerns in identity and access management systems and APIs. Currently, there are no available products or systems that effectively address these issues, leaving organizations with no alternative but to cautiously utilize existing systems, which may or may not provide a viable solution.

As can be seen, there is a need for systems and methods for robust and layered security approaches that can guarantee access to sensitive data that is controlled and secured at every instance of access.

### SUMMARY

In one aspect of the present disclosure, a method includes building, at a first computer, a list of requests for processing. The list of requests can be forwarded to a second computer, which can use a service to authenticate the list. A consumable request can be formed, by a service at the second computer, based on the list of requests. The consumable request can then be forwarded to a third computer for processing and returning a result to the second computer. The result can be aggregated into an aggregated result at the second computer and provided to a first computer via a subscription model.

In another aspect of the present disclosure, a computer-readable medium stores instructions for causing one or more processors to perform a method. The method includes building, at a first computer, a list of requests for processing. The list of requests can be forwarded to a second computer, which can use a service to authenticate the list. A consumable request can be formed, by a service at the second computer, based on the list of requests. The consumable request can then be forwarded to a third computer for processing and returning a result to the second computer. The result can be aggregated into an aggregated result at the second computer and provided to a first computer via a subscription model.

In another aspect of the present disclosure, a system includes one or more memory devices storing instructions and one or more processors. The one or more processors are configured to execute the instructions to perform a method. The method authenticates, by a first service, a list of requests, wherein the list of requests is provided by a user to the system. The method then forms, by a second service, a consumable request based on the list of requests and forwards the consumable request to a third service. The consumable request is forwarded and a result is returned to a fourth service, which is subsequently forwarded by the fourth service to the first service. The first service aggregates the consumable request to form an aggregated result, which can then be provided to a user via a subscription model.

### BRIEF DESCRIPTION OF THE DRAWINGS

FIG. 1 is a block diagram of a Zero-Trust Application Programming Interface System, according to aspects of the present disclosure;

FIG. 2 is a method responding to a user request, according to aspects of the present disclosure;

FIG. 3 is a method of dataflow between the Zero-Trust API system and a Tenant Environment, according to aspects of the present disclosure;

FIG. 4 is a method illustrating further aspects of interactions between request topics of FIG. 2, according to aspects of the present disclosure;

FIG. 5 is a method for request flow, according to aspects of the present disclosure;

FIG. 6 is a method for Request flow execution and Response Handling, according to aspects of the present disclosure; and

FIG. 7 is a method for licensing and activation data flow according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As stated above, existing tools that assist in development, testing, and CI/CD processes often fall short in terms of safeguarding sensitive data. These tools often rely on sensitive credentials like client secrets, Application Programming Interface (API) keys, privileged accounts, and service accounts to issue access tokens. The issue is that these keys are accessible to a wide range of individuals, including employees, vendors, Developer Security Operations (DevSecOps) teams, and contractors, which jeopardizes their confidentiality. When these keys are distributed, they cease to be secret, increasing the risk of unauthorized access. Furthermore, in production environments, when APIs are called through REST/SOAP clients, they may inadvertently expose personally identifiable information (PII) to developers, Testers, and/or operations personnel who do not necessarily own or have a legitimate need to access such data. This poses a significant data security risk and a potential breach of privacy.

Broadly, an embodiment of the present disclosure provides a system and method for robust and layered security approach that can guarantee access to sensitive data that is controlled and secured at every instance of access.

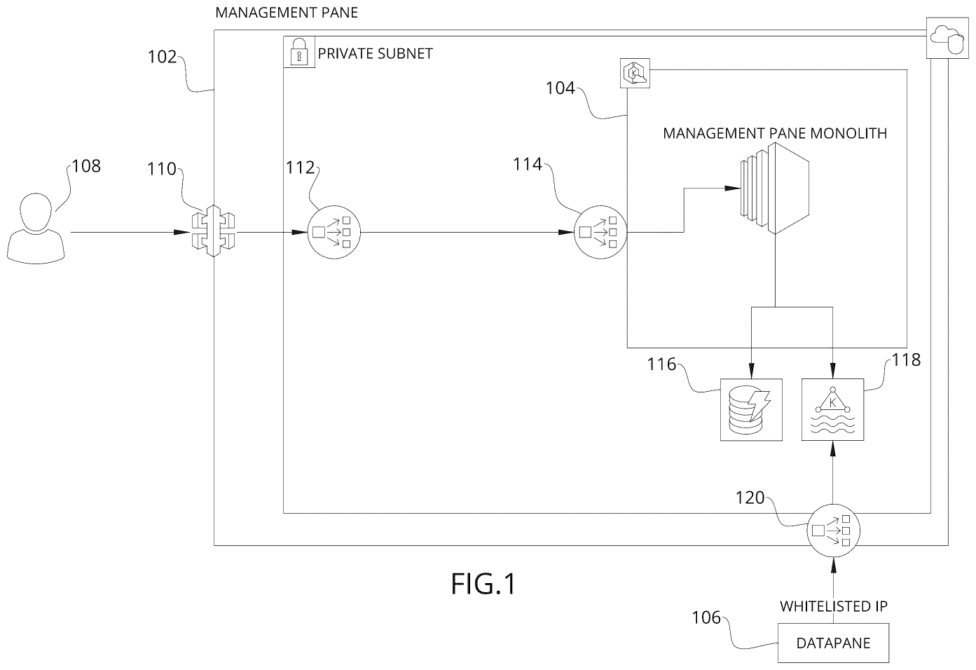

Referring now to FIG. 1, FIG. 1 illustrates an embodiment of a Zero-Trust Application Programming Interface (API) System, according to aspects of the present disclosure. The Zero-Trust API System stands out by offering a comprehensive data protection solution, integrating seamlessly with CI/CD pipelines, and ensuring secure, role-based, Ip-Based and SSO-driven access, while also providing dynamic PII masking, creating a unique and highly effective approach to safeguarding sensitive data in API management. Aspects of the Zero-Trust API system can include management pane 102 where a user 108 can login, through computing device 110, and can manage various aspects like unit testing, development, regression testing, dashboard for token lifecycle monitoring, and server health checks. Advantageously, the Zero-Trust API system can securely handle input of secrets and API keys thereby preventing user 108 from manually input sensitive data such as secrets and API keys for any of the above processes. In an embodiment, management pane 102 can be a monolithic system, but it is also envisioned that the management pane can adopt a modular structure.

Management pane 102 can also include middleware 112, 114 and 120, which can act as an intermediary between user 108 and various components of the system. Middleware 112, 114 and 120 can act as intermediaries, constructing requests using Redux and sending them to the Data pane 106 and management pane 102. Middleware 112, 114 and 120 can wait for responses, and once received from the backend, can display responses to user 108. Advantageously, Middleware 112, 114 and 120 mask any sensitive information in responses, marked as personally identifiable information (PII). Management pane 102 can include monolith 130, which can receive requests from middleware 114. Monolith 130 can include the functionality to access datastore 116 and Kafa API 118. Monolith 130 can utilize Kafka API 118 and datastore 116 for real-time event processing, event sourcing, data aggregation and event driven microservices. In one embodiment, Kafka API 118 and datastore 116 can be optimized for ingesting and processing of streaming data in real-time.

Management Pane 102 can perform the following responsibilities as part of its service. A gatekeeper service can handle Role-based Access Control (RBAC) for all modules of management pane 102, and can handle authentication and authorization, using JSON Web Token authentication mechanisms. A core service can expose management pane 102 APIs. A DP Orchestrator service can operate as a scheduler for management pane 102 by scheduling request sequences from a tenant and can retrieve and initiate request flows. A result analyzer service can analyze results and build dashboards. A config service can manage tasks related to onboarding, including creation of Kafka topics, certificate management and IP whitelisting. A license service can handle licensing within the system. A health service can monitor the health and performance of the system. Finally, a notification service can manage the generation and delivery of notifications to users or other services.

Data pane 106 can be responsible for receiving the requests, verifying their authenticity, checking user roles, and processing the request. Data pane 106 can access necessary keys and secrets from datastore 116, ensuring the response is correctly generated and returned to user 108. Data Pane 106 can be responsible for receiving incoming requests. Data pane 106 can validate the authenticity of incoming requests to prevent unauthorized access, validate user roles to ensure that only authorized actions are executed, process the request by retrieving the necessary keys and secrets from datastore 116, and generate the response in a secure and efficient manner. While FIG. 1 illustrates various components of the Zero-Trust API System, additional components can be added, and existing components can be removed.

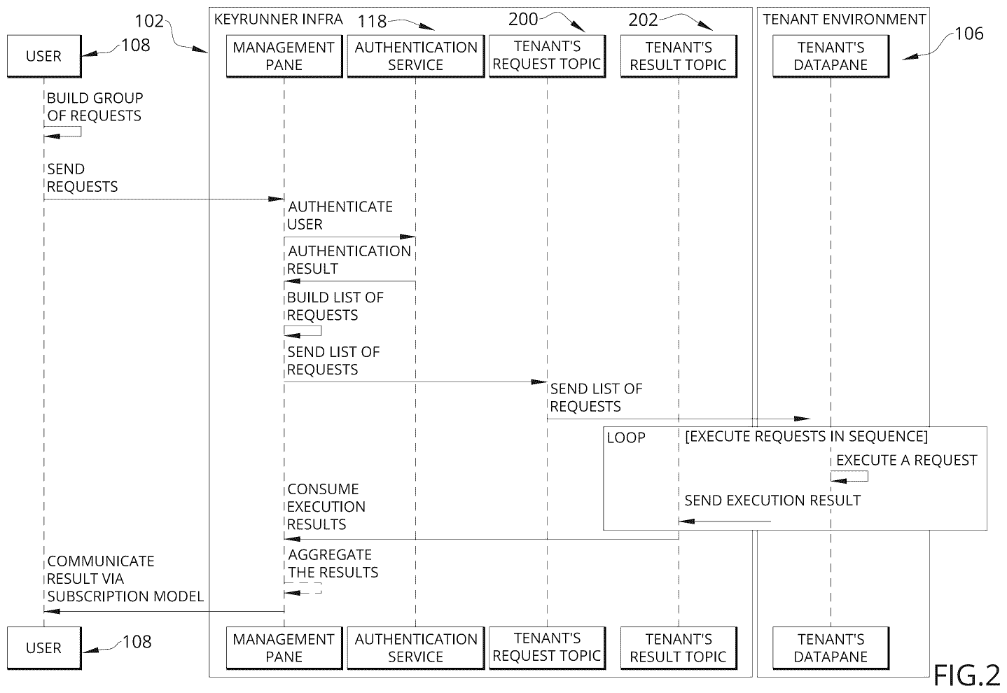

Referring now to FIGS. 2-7, the Figures disclose embodiments of dataflows in a Zero-Trust API system, according to aspects of the invention. FIG. 2 illustrates a method responding to a user request, according to aspects of the present disclosure. User 108 can build a group of requests and send the request to management pane 102, inside of Zero-Trust API system. Management pane 102 can begin authentication of user 108 by forwarding a request to Authentication Service 118, which can subsequently authenticate user 108 and return a result to management pane 102. Management pane 102 can loop through group of requests to build a list of requests, which can be sent to Tenant's Request Topic 200 for processing. Tenant's Request Topic 200 consumes a list of requests and forwards the list to tenant data pane 106. Tenant's data pane 106 can execute the forwarded list of requests by looping through each request. Once tenant's data pane 106 completes process it can return a result to Tenant's result topic 202. Notably, Tenant's data pane 106 can be in a tenant environment that can be segregated, or sandboxed, to prevent unauthorized access, or data leakage. Tenant's Result Topic 202 can forward execution results to management pane 102 for consumption and aggregation processing. Once processing is completed by management pane 102 it can be provided back to user 108 via a subscription model. While FIG. 2 illustrates various stages of the method for responding to a user request, additional stages can be added, and existing stages can be removed and/or reordered.

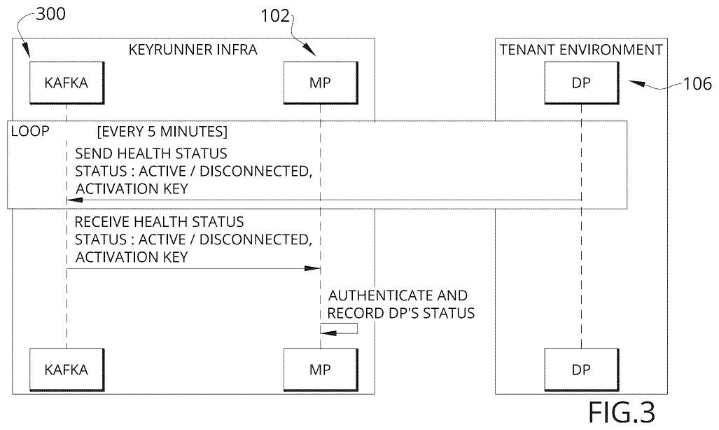

Referring now to FIG. 3, FIG. 3 illustrates a method of dataflow between the Zero-Trust API system and a Tenant Environment, according to aspects of the present disclosure. Tenant Data pane 106 can send a health status request, on a looped time incremental basis, to Kafka API 300 which can include a status information and an activation key. Kafka API 300 can receive the health status request and forward the request to the management pane 102 for authentication and processing. Management pane 102 can receive the health status request and authenticate the status of the tenant's data pane 106 and can store the status. FIG. 3 illustrates a secure request fulfillment because a tenant environment cannot have direct access to management pane 102. While FIG. 3 illustrates various stages of the method for responding to a user request, additional stages can be added, and existing stages can be removed and/or reordered.

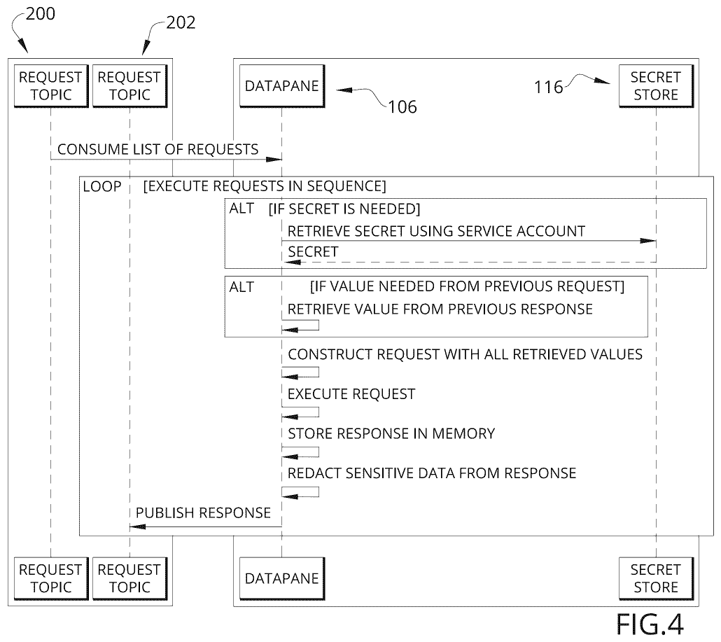

Referring now to FIG. 4, FIG. 4 illustrates further aspects of interactions between request topics 200, tenant data pane 106 and result topic 202, according to aspects of the present disclosure. As stated in FIG. 2 request topic 200 can forward a list of requests to tenant data plane 106 for consumption. Once data pane 106 receives the requests it can use the process of FIG. 4 for processing using secret or key data. Data pane 106 can request secret data from secret store 116, which can return a secret response if needed. If a secret is not needed, i.e. it is needed from a previous response, data pane 106 can retrieve the secret from a previous response without need for querying secret store 116. Once a secret is retrieved, data pane 106 can construct requests with all values. Data pane can then execute requests, store the execution results in memory, and subsequently redact sensitive data from a response. Once a request/response cycle is complete, the result can be published by data pane 106 to results topic 202. Segregation in this manner provides added levels of security and prevents data leakage. While FIG. 4 illustrates various stages of the method for responding to a user request, additional stages can be added, and existing stages can be removed and/or reordered.

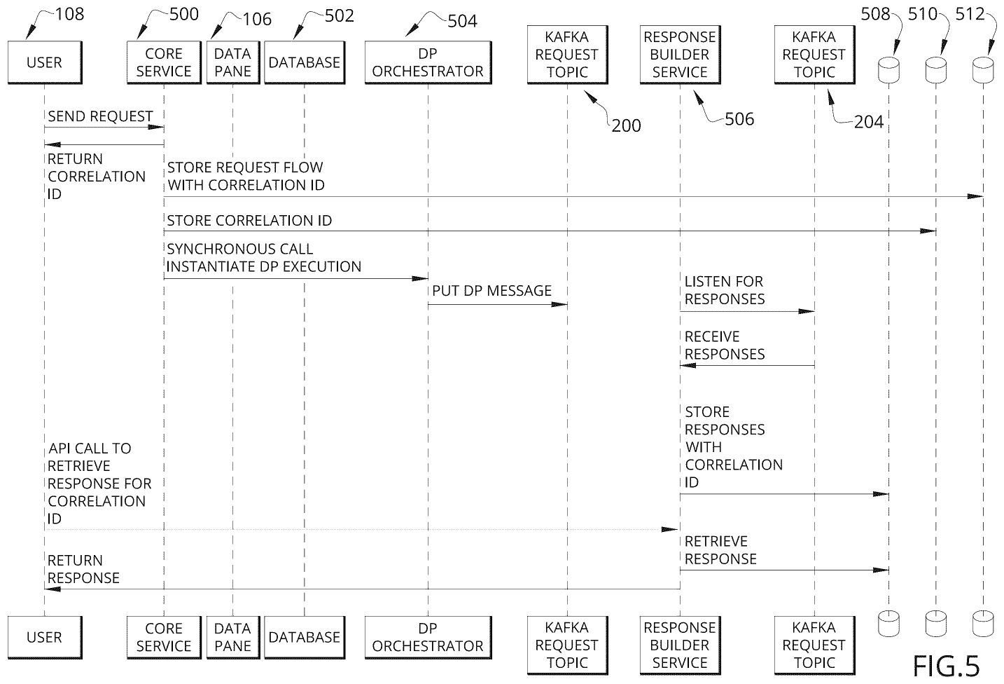

Referring now to FIG. 5, FIG. 5 illustrates further aspects of a request flow diagram, according to aspects of the present disclosure. User 108 can send a request to Core Service 500, which can return a correlation ID to user 108. The request and correlation ID can also be forwarded by Core Service 500 to request flow 512. The linkage between the request and correlation ID preserves a connection between the initial request and subsequent processing. Furthermore, correlation ID can be separately forwarded to status store 510, which can facilitate user status queries by allowing a User Interface to retrieve information about the progress and status of a request. Core Service 500 can make a synchronous call to DP orchestrator 504, which can then instantiate DP execution. DP orchestrator receives the call from core service 500 and can put a DP message to request topic 200. The primary role of DP Orchestrator 504 can be to curate tasks, which can be accomplished by providing an endpoint through which core service 500 can provide a correlation ID. DP Orchestrator 504 can utilize correlation IDs for searching and dispatching request flows to a request topic 204 dedicated to a specific tenant. Moreover, DP Orchestrator 504 can maintain a scheduler for identifying and executing request flows. Response Building 506 can listen for responses from response topic 204 and receive response topic 204. Once a response is received by response builder 506 it can forward the response and correlation ID for storage at response storage 508. In order to retrieve a response, user 108 can make an API call to response building 506 which can include a correlation ID. In response, response builder 506 can retrieve a response from response store 508 and return the response to user 108. While FIG. 5 illustrates various stages of the method for responding to a user request, additional stages can be added, and existing stages can be removed and/or reordered.

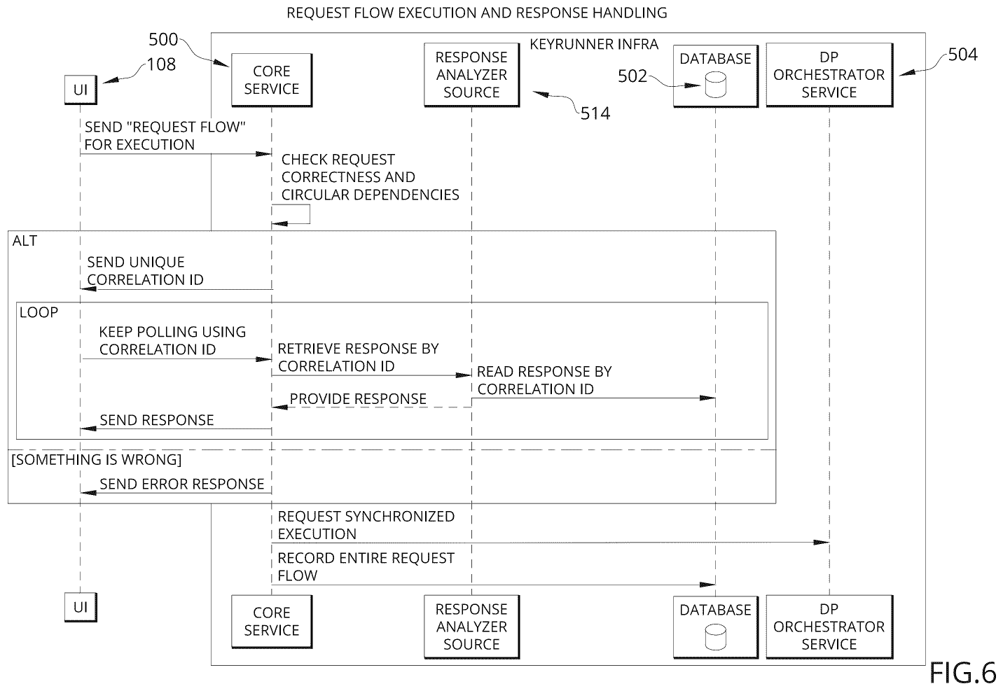

Referring now to FIG. 6, FIG. 6 illustrates Request flow execution and Response Handling, according to aspects of the present disclosure. User 108 can send a request flow for execution to core service 500. Core service 500 can check the request flow for correctness and circular dependencies. If no validation error occurs, core service 500 can provide user 108 with a correlation ID. A User Interface can continually poll core service 500 with the provided correlation ID to receive a response. During polling, core service 500 can send correlation ID to response analyzer service 514, which can retrieve a response from database 502 using the correlation ID. A response can be forwarded by response analyzer service 514 to core service 500, which can subsequently be provided to user 108. In the case that a validation error occurs, core service 500 can notify user 108 and no correlation ID is provided. Finally, core service 500 can send a request for synchronized execution to orchestrator service 504 and send a request to store flow to database 502. While FIG. 6 illustrates various stages of the method for responding to a user request, additional stages can be added, and existing stages can be removed and/or reordered.

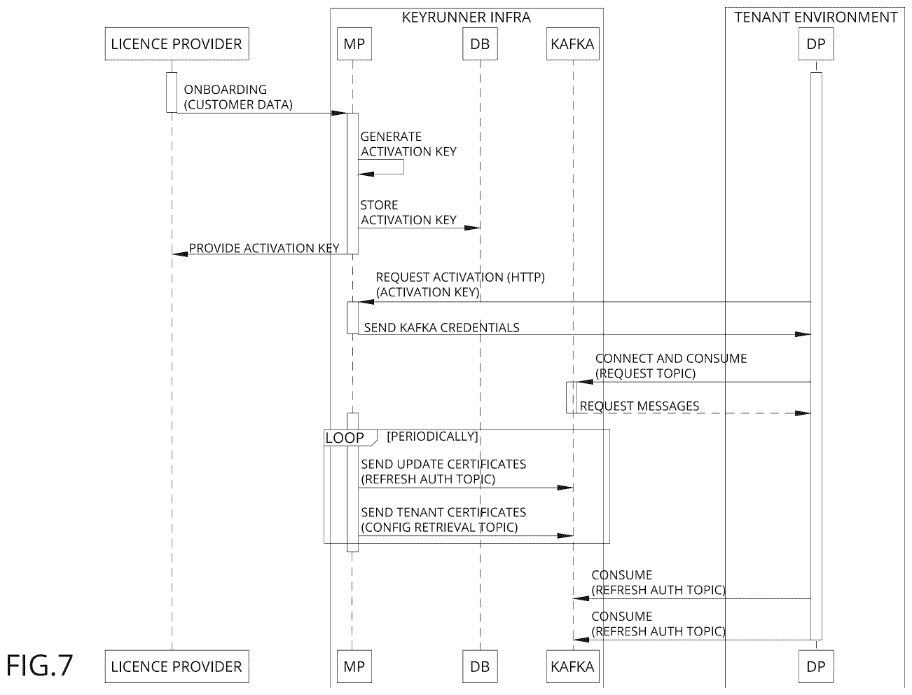

Referring now to FIG. 7, FIG. 7 illustrates licensing and activation data flow, according to aspects of the present disclosure. To begin, License provider 600 can forward customer data to management pane 102. Management pane, upon reception of customer data, can generate an activation key, and send a request to store the activation key to a database. Once an activation key is created, management pane 102 can provide the activation key to license provide 600. Tenant data pane 106 can then request activation, through secure protocols, from management pane 102. In response, management pane 102 can provide Kafka credentials to tenant data pane 106. Once activated, data pane 106 can connect and consume topics by request to Kafka 300, which can provide messages to data pane 106. Periodically, management pane 102 can send updated certificates and tenant configurations to Kafka 300. Tenant data pane 206 can consume data from Kafka 300, provided by management pane 102. While FIG. 7 illustrates various stages of the method for responding to a user request, additional stages can be added, and existing stages can be removed and/or reordered.

The Zero-Trust API system can be designed to enhance security and access control in the realm of API management and data protection. Alternatively, the Zero-Trust API principles embodied herein can implement several use cases without departing from the scope of the invention. For example, secure data sharing platforms can be implemented to share data in sensitive industries like healthcare and finance by enforcing strict access controls, role-based authorization, and masking sensitive information. The Zero-Trust API can be utilized for cloud security by monitoring and secure data exchanges between cloud services and client applications, ensuring that sensitive information is never exposed and access is strictly controlled.

In the Internet of Things (IoT) field, the Zero-Trust API technology can be used to manage and secure communication between IoT devices and data collection platforms. It can ensure that only authorized devices can access and exchange data, protecting against unauthorized access. In the financial sector, the Zero-Trust API system can be employed to secure and manage interactions between financial institutions, clients, and external partners. This can ensure the confidentiality of sensitive financial data and adherence to industry regulations. The Zero-Trust API system can be used to safeguard electronic health records (EHRs) and patient information. It can help control access, masking PII, and ensures compliance with healthcare data privacy regulations like HIPAA. Finally, for CICD pipeline the Zero-Trust API system can be consumed to provide the same functionality as fetching the secrets from secret stores to securely connect with the API's

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for providing secure access to data, the method comprising:
building, at a first computer, a list of requests for processing;
forwarding, to a second computer, the list of requests;
authenticating, by a service at the second computer, the list of requests;
forming, by a service at the second computer, a consumable request based on the list of requests;
forward, to a third computer, the consumable request;
processing, at the third computer, the consumable request and returning a result to the second computer;
aggregating, by a service at the second computer, the result to form an aggregated result; and
providing, to the first computer, the aggregated result by a subscription model.

2. A computer-readable medium storing instructions that cause one or more processors to perform a method, the method comprising:
building, at a first computer, a list of requests for processing;
forwarding, to a second computer, the list of requests;
authenticating, by a service at the second computer, the list of requests;
forming, by a service at the second computer, a consumable request based on the list of requests;
forward, to a third computer, the consumable request;
processing, at the third computer, the consumable request and returning a result to the second computer;
aggregating, by a service at the second computer, the result to form an aggregated result; and
providing, to the first computer, the aggregated result by a subscription model.

3. A system, comprising:
a gatekeeper module for handling at least one role-based access control request;
a core service module for exposing at least one APIs of the system to an external users;
an orchestrator module for scheduling at least one request sequences and at least one executing request flows; and
a result module for building dashboard based on at least one received result, wherein the gatekeeper module, core service module, orchestrator module and result module are stored in at least one memory, and configured to be executed by at least one processor.

4. The system of claim 3, further comprising:
at least one additional module comprising:
a configuration module for managing at least one task related to the system configuration;
a license module for managing at least one license for the system;
a health module for monitoring a health or performance metric of the system; or
a notification module for managing generation and delivery of at least of notification of the system.
